(19) United States
(12) Patent Application Publication
(10) Pub. No.: US 2018/0361658 A1
(43) Pub. Date: Dec. 20, 2018

(54) ADHESION PROMOTING LAYER TO IMPROVE INTERLAYER ADHESION IN ADDITIVE MANUFACTURING PROCESSES

(71) Applicant: SABIC GLOBAL TECHNOLOGIES B.V., Bergen op Zoom (NL)

(72) Inventors: Satish Kumar Gaggar, Hoover, AL (US); Malvika Bihari, Evansville, IN (US)

(21) Appl. No.: 16/060,551

(22) PCT Filed: Dec. 8, 2016
(86) PCT No.: PCT/US2016/065618

§ 371 Date: Jun. 8, 2018

Related U.S. Application Data
(60) Provisional application No. 62/266,019, filed on Dec. 11, 2015.

(51) Int. Cl. B29C 64/118; B29C 64/209; B29C 64/245

(52) U.S. Cl. CPC B29C 64/118; B33Y 10/00; B29C 64/245; B29C 64/209

(57) ABSTRACT

Disclosed is a method of making an article, the method comprising: melt extruding a plurality of layers comprising one or more polymer compositions in a preset pattern, wherein the extruded layers comprise one or more first layers comprising a first polymer composition A, and one or more second layers comprising a second polymer composition B having a chemical composition different from the first polymer composition A, having a glass transition temperature (Tg) that is 5-100 degrees C. lower than polymer composition A, and which acts as a adhesion promotion layer between two layers comprising first polymer composition A; and fusing the plurality of layers to provide the article.

### BACKGROUND

Additive manufacturing (also known in the art as “three-dimensional or “3D” printing) is a process for the manufacture of three-dimensional objects by formation of multiple fused layers. Interlayer adhesion between two adjacent fused layers is a critical parameter in some applications, because it can affect a variety of properties such as mechanical strength. If a three-dimensional object does not have the desired mechanical strength, it can limit, for example, the load-bearing ability of such objects. Thus, there remains a need in the art for additive manufacturing processes that produce objects with improved interlayer adhesion.

### BRIEF DESCRIPTION

One embodiment is a method of making an article, the method comprising: melt extruding a plurality of layers comprising one or more polymer compositions in a preset pattern, wherein the extruded layers comprise one or more first layers comprising a first polymer composition A, and one or more second layers comprising a second polymer composition B having a chemical composition different from the first polymer composition A, having a glass transition temperature (Tg) that is 5-100 degrees C. lower than polymer composition A, and which acts as a adhesion promotion layer between two layers comprising first polymer composition A; and fusing the plurality of layers to provide the article.

Another embodiment is an article comprising a plurality of at least twenty fused layers, each layer comprising a polymer composition, wherein one or more first layers comprising a first polymer composition A, and one or more second layers comprising a second polymer composition B having a chemical structure different from the first polymer, having a glass transition temperature (Tg) that is 5-100 degrees C. lower than polymer composition A, and which acts as a adhesion promotion layer between two layers comprising first polymer composition A, wherein the first thermoplastic polymer composition A and the second thermoplastic polymer composition B are miscible or compatible with each other.

The above described and other features are exemplified by the following figures and detailed description.

### DETAILED DESCRIPTION

Disclosed herein are additive manufacturing methods to improve interlayer adhesion in melt extruded AM printed parts. An adhesion promoter layer containing polymer of the same parent polymer or a miscible polymer that can act as glue between two consecutive layers is used, thus improving the interlayer adhesion. Some of the examples for adhesion promoter layer can be resin/solvent paste, highly plasticized polymer and very low molecular weight polymer. A dual nozzle melt extrusion apparatus can be used where parent layer will be deposited from one nozzle and an adhesion promoter layer will be deposited alternately from the second nozzle. This cycle can be repeated to print the part. Interfacial strength may be improved through solvent induced bonding or increased chain mobility in plasticized or very low mol wt polymer.

As stated above, multiple layers of different polymer compositions are extruded in a preset sequence. As used herein, “multiple layers” is used in reference to the number of layers in a sequence of polymer compositions, whereas “plurality of layers” is used to refer to the total number of layers used to form the printed object. The number of layers in a sequence of polymer compositions is at least two, and can be up to the total number of layers used to form the article. The number of layers in a sequence depends on the particular sequence of polymer compositions selected, based on the desired properties of the printed object. For example, the number of layers per sequence can be 2 to 200, or 2 to 100, or 2 to 50, or 2 to 20, or 2 to 10. In some embodiments the number of layers per sequence includes 2, 3, 4, 5, or 6 layers.

As used herein, “layer” is a term of convenience that includes any shape, regular or irregular, having at least a predetermined thickness. In some embodiments, the size and configuration two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments the thickness of each layer as formed is 0.5 millimeters (mm) to 5 mm.

As stated above, a three dimensional article is manufactured by extruding a plurality of layers in a preset pattern by an additive manufacturing. The material extrusion techniques include techniques such as fused deposition modeling and fused filament fabrication as well as others as described in ASTM F2792-12a. Any additive manufacturing process can be used, provided that the process allows formation of at least two adjacent layers comprising different polymer compositions. In some embodiments, more than two adjacent layers are extruded comprising different polymer compositions. The methods herein can be used for fused deposition modelling (FDM), Big Area Additive Manufacturing (BAAM), ARBURG plastic free forming technology, and other additive manufacturing methods.

In some embodiments, large format additive manufacturing systems are employed. These systems utilize pellets of polymeric material in hoppers or bins to form parts. A large extruder converts these pellets to a molten form that are then deposited on a table. Large format additive manufacturing system generally comprise a frame or gantry that may include a print head that is moveable in x,y and/or z direction. Alternately, the print head may be stationary and the part is moveable in x, y and/or z axis. The print head has a supply of feed material in the form of pellets or filament and a deposition nozzle. The polymeric material is stored in a hopper (for pellets) or similar storage vessel near the deposition arm or supplied from a filament spool. The apparatus can include a nozzle for extruding a material. The polymeric material from the barrel is extruded through the nozzle and directly deposited on the build. A heat source may be positioned on or in connection with the nozzle to heat the material to a desired temperature and/or flow rate. The bed may be heated or at room temperature. For some embodiments of large format additive manufacturing systems, the pellets can have a cross-sectional dimension in the range of 0.1 mm to 50 mm, or an aspect ratio of 1 to 10, or combinations thereof. One example of such large format additive manufacturing systems is the Big Area Additive Manufacturing (or BAAM) system developed by Oak Ridge National Laboratory and Cincinnati Manufacturing. BAAM technology is described in US Published Patent Application Nos. 2015/0183159 A1, 2015/0183138 A1, and 2015/0183164 A1 and U.S. Pat. No. 8,951,303 B1, all of which are incorporated herein by reference in their entireties. One embodiment of the extruder for the BAAM system is designed for extruding thermoplastic pellets at 35 lbs/hour through a nozzle and onto a print bed 157×78×34 inches. Estimated throughput of extruder increased to 50-100 lbs/hour with expanded capability. Temperature Max: 500 deg C.; 4 heating zones.

For other embodiments, the polymer compositions are also suitable for use in droplet-based additive manufacturing systems, e.g., the Freeformer™ system by Arburg.

In fused material extrusion techniques, an article can be produced by heating a polymer composition to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted polymer composition fuses to the previously deposited layer, and solidifies upon a drop in temperature. Extrusion of multiple subsequent layers builds the desired shape.

The total number of layers in the article can vary significantly. Generally, but not always, at least 20 layers are present. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed. The plurality of layers in the predetermined pattern is fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

The preset pattern can be determined from a three-dimensional digital representation of the desired article as is known in the art and described in further detail below. In particular, an article can be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

In some embodiments, an additive manufacturing technique known generally as material extrusion can be used. In material extrusion, an article can be formed by dispensing a flowable material in a layer-by-layer manner and fusing the layers. “Fusing” as used herein includes the chemical or physical interlocking of the individual layers. The flowable material can be rendered flowable by dissolving or suspending the material in a solvent. In other embodiments, the flowable material can be rendered flowable by melting. In other embodiments, a flowable prepolymer composition that can be crosslinked or otherwise reacted to form a solid can be used. Fusing can be by removal of the solvent, cooling of the melted material, or reaction of the prepolymer composition.

In some embodiments the layers are extruded from two or more nozzles. In some embodiments the layers are extruded such that all of the layers comprising a given polymer composition are extruded from the same nozzle, and any layers comprising a different polymer composition are extruded from a different nozzle. For example, in a pattern of three compositions A, B, and C, one nozzle extrudes only polymer composition A, one nozzle different from the A nozzle extrudes only polymer composition B, and one nozzle different from the A and B nozzles extrudes only polymer composition C.

In some embodiments, each nozzle extrudes only a given polymer composition (for example, A, B, or C) but there can be multiple nozzles for each composition.

In some embodiments different polymer compositions are extruded from the same nozzle. This can facilitate creation of a variety of layers comprising mixtures of polymers with different ratios. This can particularly facilitate extruding layers in which a sequence of layers form a gradient of mixtures of different polymers.

If multiple nozzles are used, the method can produce the product objects faster than methods that use a single nozzle, and can allow increased facility in terms of using different polymers or blends of polymers, different colors, or textures, and the like.

In some embodiments a support material as is known in the art can optionally be used to form a support structure. In these embodiments, the build material and the support material can be selectively dispensed during manufacture of the article to provide the article and a support structure. The support material can be present in the form of a support structure, for example, a scaffolding, that can be mechanically removed or washed away when the layering process is completed to the desired degree. For some embodiments, the build structure and the support structure of the article formed can be extruded using different polymer compositions or different polymer composition sequences. In other embodiments, at least one support structure layer and one adjacent build structure layer are extruded using different polymer compositions or different polymer composition sequences.

Systems for material extrusion are known. An exemplary material extrusion additive manufacturing system includes a build chamber and a supply source for the polymer composition. The build chamber includes a build platform, a gantry, and a dispenser for dispensing the polymer composition, for example an extrusion head. The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other. Alternatively the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions.

In some embodiments, the support structure can be made purposely breakable, to facilitate breakage where desired. For example, the support material can have an inherently lower tensile or impact strength than the build material. In other embodiments, the shape of the support structure can be designed to increase the breakability of the support structure relative to the build structure.

For example, in some embodiments, the build material can be made from a round print nozzle or round extrusion head. A round shape as used herein means any cross-sectional shape that is enclosed by one or more curved lines. A round shape includes circles, ovals, ellipses, and the like, as well as shapes having an irregular cross-sectional shape. Three dimensional articles formed from round shaped layers of build material can possess strong structural strength. In other embodiments, the support material for the articles can be made from a non-round print nozzle or non-round extrusion head. A non-round shape means any cross-sectional shape enclosed by at least one straight line, optionally together with one or more curved lines. A non-round shape can include squares, rectangles, ribbons, horseshoes, stars, T head shapes, X shapes, chevrons, and the like. These non-round shapes can render the support material weaker, brittle and with lower strength than round shaped build material.

In some embodiments, the lower density support materials can be made from a non-round print nozzle or round extrusion head. These non-round shaped lower density support materials can be easily removed from build materials, particularly higher density round shaped build materials.

In some embodiments the polymer composition is supplied in a melted form to the dispenser. The dispenser can be configured as an extrusion head. The extrusion head can deposit the thermoplastic composition as an extruded material strand to build the article. Examples of average diameters for the extruded material strands can be from 1.27 millimeters (0.050 inches) to 3.0 millimeters (0.120 inches). Depending on the type of polymer composition, the polymer composition can be extruded at a temperature of 200 to 450° C. In some embodiments the polymer composition can be extruded at a temperature of 300 to 415° C. The layers can be deposited at a build temperature (the temperature of deposition of the thermoplastic extruded material) that is 50 to 200° C. lower than the extrusion temperature. For example, the build temperature can be 15 to 250° C. In some embodiments the polymer composition is extruded at a temperature of 200 to 450° C. or 300 to 415° C. and the build temperature is maintained at ambient temperature.

As used herein, “polymer composition” refers to a composition that includes one or more polymers, and can optionally include one or more additives known in the art. A polymer composition can consist of a single polymer and nothing else, for example a polymer composition can be polystyrene. Alternatively, a polymer composition can be a combination of polymers, such as 30% polystyrene and 70% poly(phenylene ether). Alternatively, a polymer composition can be one or more polymers and one or more additives, for example a polymer composition can include 30% polystyrene, 70% poly(phenylene ether), a flame retardant, and an impact modifier.

As used herein, two polymer compositions are “different” if they comprise different polymers, different ratios of the same polymers, different additives, or different levels of the same additives. For example, a polymer composition that is 30% polystyrene, 70% poly(phenylene ether) is different from a polymer composition that is 70% polystyrene, 30% poly(phenylene ether). In some embodiments, where different polymer compositions are identical except for a different amount of a component, the amount of the component can vary by at least +1-5%. For example, a polymer composition having 1.00 weight percent (wt. %) of a flame retardant can differ from the identical composition if it contains 0.95 wt. % or less, or 1.05 wt. % or more of the same flame retardant. In some embodiments, the amount of a component varies by at least +/−10%, or at least +/−20%.

As used herein, two polymers are “different” if they have a different chemical composition, structure, or other property. This can mean, for example, that the polymers comprise different monomers (e.g. polymethyl methacrylate and polyethylene oxide), or the same monomers arranged in a different orientation or linkage, or copolymers with different ratios of constituent monomers, or have different levels of crosslinking. Polymers can also differ if each as a different regiochemistry or configuration, molecular weight, molecular weight distribution, dispersity index, density, hydrophobicity, or other characteristic that affects a polymer property. Where the difference is measured numerically (ratios of copolymers, for example), at least one component can have a level or measurement in one polymer that is at least +/−5% different from the other polymer. In some embodiments, the difference is at least +/−10%, or at least +/−20%. In some embodiments, the first and second polymer compositions, and optionally additional polymer compositions, are compatible with each other at an interface between them. For the purpose of these embodiments, “compatible with each other at an interface” means that there are sufficiently strong interfacial interactions between the polymer compositions, such as adhesion at the interface, or attractive forces due to physical interactions at the interface. Preferably there is no repulsion and no delamination at the interface. An interface between two polymer compositions preferably has adequate interfacial strength. Interfacial strength (or inter-layer bonding) between adjacent layers of two different polymer compositions can be defined as the force required to peel off or separate the two adjacent layers of two different polymer compositions. Interfacial strength can be measured, for example, by the lap shear test or the peel test. The lap shear test is a qualitative adhesion test method which can be used to predict interlayer adhesion for the printed objects of the disclosure. The polymer composition is molded into flame bars with thickness of 1 mm. Two flame bars of the same or different polymer composition are clamped together and placed in an oven at a temperature 3-5° C. higher than the glass transition temperature of the polymer composition. After cooling the flame bars, the adhesion is characterized as.
i. Weak, for the flame bars which can be pulled apart easily,
ii. Medium, for the flame bars which get welded (due to above-mentioned heat treatment) but still can be pulled apart while the flame bars remaining intact, and
iii. Strong, for the flame bars which get completely welded (due to above-mentioned heat treatment) and cannot be pulled apart without breaking.

In still other embodiments, the different polymers are fully compatible, including blendable or fully miscible, not just at the interface, but also in bulk. For example, poly(phenylene ether) and polystyrene are miscible with each other at all concentrations in bulk. And, such compatible or miscible polymers are always compatible at the interface when printed as alternate layers.

In the method, a first layer comprises polymer composition A; and a second layer is extruded on the first layer wherein the second layer comprises polymer composition B. As used herein “extruded on” and “adjacent” means that the two layers directly contact each other, and no intervening layers are present. The sequence of polymer compositions is selected to provide the desired properties of the article. Where an alternating sequence of a first polymer composition A and a second polymer composition B is used, the sequence of polymer compositions can be expressed as (AB)x, where x is number of times the sequence is repeated and is at least 1. Other polymer composition sequences based on polymer compositions A and B can be used, for example the sequence AABBAABB . . . , which can be expressed as (A2B2)x, or AAABB, which can be expressed as (A3B2)x, or ABBB, which can be expressed as (AB3)x. Thus, in an embodiment, the method comprises melt extruding the plurality of layers in a polymer composition sequence (ApBq)x where p is the number of adjacent layers extruded comprising polymer composition A, and q is the number of adjacent layers extruded comprising polymer composition B. The variables p and q can be the same or different. In some embodiments, the variable p and q are each independently 1 to 30, preferably 1 to 20, more preferably 1 to 10, even more preferably 1 to 5. Further in the foregoing formula, x is at least 1.

All or a portion of the plurality of layers used to form the article can be extruded using a given polymer composition sequence. In some embodiments, all of the plurality of layers of the article are formed using the polymer composition sequence, for example the sequence AB. In other embodiments, a portion of the layers in the article are formed using the polymer composition sequence. The polymer composition sequence can be used to vary the properties of the article in a region of the article, for example provide increased tensile modulus or flexural modulus to the region. The number of layers formed using the polymer composition sequences can be represented by the formula (p+q)*x. In some embodiments. (p+q)*x is at least 1%, at least 10%, at least 25%, at least 50%, at least 80%, or at least 90% of the total number of layers in the article. Alternatively, as described above. (p+q)*x can be the total number of layers in the article.

In still other embodiments, two or more different polymer composition sequences can be used to form an article. For example, a sequence (AB)x1 can be used to form the layers of one portion of an article, and a sequence (A2B)x2 can be used to form the layers of a different portion of the article. The multiple layers formed by each sequence can be adjacent each other, or separated by other layers comprising a single polymer composition, e.g., multiple layers formed comprising polymer composition A or B, or a third, different polymer composition.

In some embodiments, one or more additional layers are extruded on the second layer. For example, the method can further comprise melt extruding 1+n additional layers comprising polymer compositions C(1+n), where n is 0, or 1, or greater than 1, up to 2 less than the total number of layers in the article. When n is zero, one additional layer (a third layer) is extruded onto the second layer comprising polymer composition C(1), which may be referred to herein as “C” for convenience. When n is one, two additional layers (third and fourth layers) are present, where the third layer is extruded on the second layer comprising polymer composition C(1), and the fourth layer is extruded onto the third layer comprising polymer composition C(2). When n is 2, three additional layers (third, fourth and fifth layers) are present, where the third layer is extruded on the second layer comprising polymer composition C(1), the fourth layer is extruded on the third layer comprising polymer composition C(2), and the fifth layer is extruded on the fourth layer comprising polymer composition C(3), and so forth. In some embodiments, n is 0, 1, 2, 3, or 4.

Where three different extrusion polymer compositions are used in a sequence, where A is a first polymer composition, B is a second polymer composition, and C is a third polymer composition, adjacent layers can be extruded comprising polymer compositions in the sequence ABCABC . . . which can be expressed as (ABC)y, or (ApBqC(1)r)y, where p is 1, q is 1, and y is the number times the sequence is repeated during formation of the article. Thus, in some embodiments, the method comprises melt extruding the multiple layers in polymer composition sequence (ApBqC(1)r . . . C(1+n)z)y, where p is the number of adjacent layers extruded comprising polymer composition A, q is the number of adjacent layers extruded comprising polymer composition B, r is the number of adjacent layers extruded comprising polymer composition C(1), and z is the number of layers extruded comprising polymer composition C(1+n). Each of p, q, r, and z can be the same or different. In some embodiments each of p, q, R, and z is independently 1 to 30, preferably 1 to 20, more preferably 1 to 10, even more preferably 1 to 5. The variable y is number of times the sequence is repeated. Preferably, (p+q+r+ . . . +z)*y is at least 1%, at least 10%, at least 25%, at least 50%, at least 80%, or at least 90% of the total number of layers in the article.

In addition to the simple sequences described above, more complex sequences can be used to attain the desired properties.

Some examples of polymer composition sequences that can be used include

([AₚB_{q}]_{g}C(1)ᵣ)_{y} or

(Aₚ[B_{q}C(1)ᵣ]_{g})_{y}

wherein the variables p, q, r, and y are as defined above, and each g is the same or different and is the number of times the subsequence [AₚB_{q}] or [B_{q}C(1)ᵣ] is repeated, and is at least two, for example 2 to 30, 2 to 20, 2 to 10, or 2 to 5.

Other examples of sequences that can be used include

(AₚB_{q1}C(1)ᵣB_{q2})_{y}

([AₚB_{q1}]_{g}C(1)ᵣB_{q2})_{y}

(Aₚ[B_{q1}C(1)ᵣ]_{g}B_{q2})_{y}

(AₚB_{q1}[C(1)ᵣB_{q2}]_{g})_{y}

([AₚB_{q1}C(1)ᵣ]_{g}B_{q2})_{y}

(Aₚ[B_{q1}C(1)ᵣB_{q2}]_{g})_{y}, or

([AₚB_{q1}]_{g1}[C(1)ᵣB_{q2}]_{g2})_{y},

wherein the variables p, r, g and y are as defined above, q1 and q2 are the same or different and q1+q1 is the total number of layers comprising polymer composition B; and each g, g1, and g2 is the same or different and is the number of times each subsequence is repeated, and is at least 2, for example 2 to 30, 2 to 20, 2 to 10, or 2 to 5.

Still other examples include

(Aₚ₁B_{q}Aₚ₂C(1)ᵣ)_{y},

([Aₚ₁B_{q}]_{g}Aₚ₂C(1)ᵣ)_{y}

(Aₚ₁[B_{q}Aₚ₂]_{g}C(1)ᵣ)_{y}

(Aₚ₁B_{q}[Aₚ₂C(1)ᵣ]_{g})_{y}

([Aₚ₁B_{q}Aₚ₂]_{g}C(1)ᵣ)_{y}

(Aₚ₁[B_{q}Aₚ₂C(1)ᵣ]_{g})_{y} or

([Aₚ₁B_{q}]_{g1}[Aₚ₂C(1)ᵣ]_{g2})_{y},

wherein the variables q, r, g, g1, g2, and y are as defined above, p1 and p2 can be the same or different and p1+p2 is the total number of layers deposited comprising polymer composition A.

Still other examples include

(AₚB_{q}C(1)ᵣ[B_{q}C(2)ₛ]_{g})_{y}, or

(AₚB_{q}C(1)ᵣ[BₛC(2)ₛA_{q}]_{g})_{y}, or

(AₚB_{q}C(1)ᵣ[BₛC(2)ₛB_{q}]_{g})_{y}, or

(AₚB_{q}C(1)ₛ[B_{q}Aₜ]_{g})_{y}, or

(AₚB_{q}C(1)ᵣ[B_{q}AₜB_{q}]_{g})_{y}, or

(AₚB_{q}C(1)ᵣ[B_{q}AₜC(2)ₛ]_{g})_{y},

wherein the variables p, q, r, s, g, and y are as defined above and u is the number of layers deposited comprising polymer composition C(2).

A wide variety of polymer compositions can be used, provided that the polymer compositions can be extruded at different temperatures. Preferably the polymers are those known as thermoplastic polymers. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylenesulfone (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Polyacetals, polyamides (nylons), polycarbonates, polyesters, polyetherimide, polyolefins, and polystyrene copolymers such as acrylonitrile butadiene styrene (ABS), are especially useful in a wide variety of articles, have good processability, and are recyclable.

Examples of thermoplastic polymers that can be used include polyacetals, polyacrylates, polyacrylics, polyamideimides, polyamides, polyanhydrides, polyaramides, polyarylates, polyarylene ethers (e.g., polyphenylene ethers), polyarylene sulfides (e.g., polyphenylene sulfides), polyarylsulfones, polycarbonates (including polycarbonate copolymers such as polycarbonate-siloxanes, polycarbonate-esters, and polycarbonate-ester-siloxanes), polyesters (e.g., polyethylene terephthalates and polybutylene terephthalates), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), polyolefins (e.g., polyethylenes, polypropylenes, polytetrafluoroethylenes, and their copolymers), polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polythioesters, polytriazines, polyureas, polyvinyl alcohols, polyvinyl esters, polyvinyl ethers, polyvinyl halides, polyvinyl ketones, polyvinylidene fluorides, polyvinyl aromatics, polyarylene sulfones, polyaryl ether ketones, poly(phenylene oxide), poly(methyl methacrylate), styrene-acrylonitrile, poly(ethylene oxide), epichlorohydrin polymer, polylactic acid, polyglycolic acid, poly-3-hydroxybutyrate, polyhydroxyalkanoate, thermoplastic starch, cellulose ester, silicones, or the like, or a combination comprising at least one of the foregoing thermoplastic polymers. In some embodiments, polyacetals, polyamides (nylons), polycarbonates, polyesters, polyetherimides, polyolefins, and polystyrene copolymers such as acrylonitrile butadiene styrene, are especially useful in a wide variety of articles, have good processability, and are recyclable.

In some embodiments, the thermoplastic polymer that can be used in both thermoplastic polymer compositions A and B is a polycarbonate (including homopolymers and copolymers that include carbonate units), elastomer-modified graft copolymer, polyester, polyolefin, polyetherimide, polyetherimide sulfone, polyphenylene sulfide, polysulfone, polyketone, polyphenylene ether, polystyrene, polyacrylate ester, polymethacrylate ester, or a combination comprising at least one of the foregoing.

Exemplary polycarbonates are described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used.

In a specific embodiment, the polycarbonate is a homopolymer derived from BPA, for example a linear homopolycarbonate containing bisphenol A carbonate units, such as that available under the trade name LEXAN from the Innovative Plastics division of SABIC. A branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name CFR from the Innovative Plastics division of SABIC can be used.

In other embodiments, the polycarbonate is a copolymer derived from BPA and another bisphenol or dihydroxy aromatic compound such as resorcinol (a “copolycarbonate”). A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation XHT from the Innovative Plastics division of SABIC); a copolymer comprising bisphenol A carbonate units and 1,1-bis(4-hydroxy-3-methylphenyl)cyclohexane carbonate units (a BPA-DMBPC copolymer) commercially available under the trade designation DMC from the Innovative Plastics division of SABIC; and a copolymer comprising bisphenol A carbonate units and isophorone bisphenol carbonate units (available, for example, under the trade name APEC from Bayer.

Other polycarbonate copolymers include poly(siloxane-carbonate)s, poly(ester-carbonate) s, poly(carbonate-ester-siloxane)s, and poly(aliphatic ester-carbonate)s. Specific poly(carbonate-siloxane)s comprise bisphenol A carbonate units and siloxane units, for example blocks containing 5 to 200 dimethylsiloxane units, such as those commercially available under the trade name EXL from the Innovative Plastics division of SABIC. Examples of poly(ester-carbonate) s includes poly(ester-carbonate)s comprising bisphenol A carbonate units and isophthalate-terephthalate-bisphenol A ester units, also commonly referred to as poly(carbonate-ester) s (PCE) or poly(phthalate-carbonate)s (PPC), depending on the relative ratio of carbonate units and ester units. Other poly(ester-carbonates include containing bisphenol A carbonate units and isophthalate/terephthalate esters of resorcinol, such as those available under the trade name SLX the Innovative Plastics division of SABIC is a poly(ester-carbonate-siloxane) comprising bisphenol A carbonate units, isophthalate-terephthalate-bisphenol A ester units, and siloxane units, for example blocks containing 5 to 200 dimethylsiloxane units, such as those commercially available under the trade name FST from the Innovative Plastics division of SABIC. Poly(aliphatic ester-carbonate)s can be used, such as those comprising bisphenol A carbonate units and sebacic acid-bisphenol A ester units, for example those commercially available under the trade name LEXAN HFD from the Innovative Plastics division of SABIC.

Other copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). In some embodiments the elastomer-modified graft copolymers include acrylonitrile butadiene styrene (ABS).

For some embodiments, polycarbonate polymer composition called PC 1 can be used. PC 1 is a standard linear BPA polycarbonate that has an approximately 7 melt flow and a weight average molecular weight (Mw) of around 29,000.

Any additive that will lower the glass transition temperature (Tg) of polymer composition B by 5-100 degrees C. than the glass transition temperature (Tg) of the polymer composition A can be added to Polymer composition B. Additives that reduce the Tg of the thermoplastic polymer composition B can include one or more non-brominated and non-chlorinated organic phosphorus-containing plasticizers such as an aromatic phosphate of the formula (GO)₃P═O, wherein each G is independently an alkyl, cycloalkyl, aryl, alkylaryl, or aralkyl group, provided that at least one G is an aromatic group. Two of the G groups can be joined together to provide a cyclic group, for example, diphenyl pentaerythritol diphosphate. Aromatic phosphates include, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

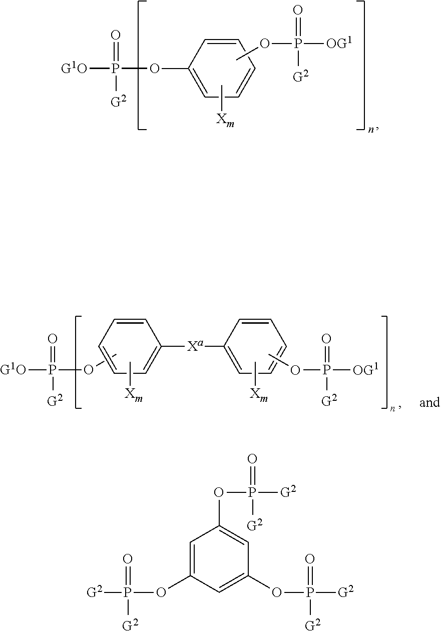

wherein each G¹ is independently a hydrocarbon having 1 to 30 carbon atoms; each G² is independently a hydrocarbon or hydrocarbonoxy having 1 to 30 carbon atoms; each X is independently a bromine or chlorine; m is 0 to 4, and n is 1 to 30. Di- or polyfunctional aromatic phosphorus-containing compounds of this type include resorcinol tetraphenyl diphosphate (RDP), the bis(diphenyl) phosphate of hydroquinone and the bis(diphenyl) phosphate of bisphenol A, respectively, their oligomeric and polymeric counterparts, and the like.

Additionally, organophosphorus compounds may be suitable as an Tg-lowering additive for the compositions of the present invention. Known compounds including monophosphate esters such as, for example, triphenyl phosphate, tricresyl phosphate, tritolyl phosphate, diphenyl tricresylphosphate, phenyl bisdodecyl phosphate, ethyl diphenyl phosphate, as well as diphosphate esters and oligomeric phosphates such as, for example, resorcinol diphosphate, diphenyl hydrogen phosphate, 2-ethylhexyl hydrogen phosphate have been found to be useful. Suitable oligomeric phosphate compounds are set forth in co-assigned U.S. Pat. No. 5,672,645 the disclosure of which is hereby incorporated herein by reference.

Non-phosphorus additives and brominated or chlorinated phosphorus additives may also be added to polymer composition B to lower its Tg.

The amount of Tg-lowering additive can vary from 1% to 30%, from 2% to 25%, or from 5% to 20% or any range within 1% to 30%, by weight, based on the weight of the polymer composition B.

Both polymer compositions A and B can include various other additives ordinarily incorporated into polymer compositions of this type, with the proviso that any additives is selected so as to not significantly adversely affect the desired properties of the thermoplastic composition, in particular the adhesion properties. Such additives can be mixed at a suitable time during the mixing of the components for forming the composition. Additives include nucleating agents, fillers, reinforcing agents, antioxidants, heat stabilizers, light stabilizers, ultraviolet (UV) light stabilizers, lubricants, mold release agents, surfactants, antistatic agents, colorants such as titanium dioxide, carbon black, and organic dyes, surface effect additives, radiation stabilizers, flame retardants, and anti-drip agents. A combination of additives can be used, for example a combination of a heat stabilizer and ultraviolet light stabilizer. In general, the additives are used in the amounts generally known to be effective. For example, the total amount of the additives (other than any impact modifier, filler, or reinforcing agents) can be 0.01 to 5 wt. %, based on the total weight of the thermoplastic material.

The phrase “wherein the first polymer composition A and the second thermoplastic polymer composition B are miscible or compatible with each other” used in the present specification and claims is includes polymers that are immiscible, but exhibit macroscopically uniform physical properties when blended.

In some embodiments, the first thermoplastic polymer composition A and the second thermoplastic polymer composition B are different.

In some embodiments, the second thermoplastic polymer composition B comprises a solvent/resin paste, low molecular weight polymer or oligomer or a highly plasticized polymer, or a combination comprising at least one of the foregoing thermoplastic polymers.

### EXAMPLES

Five formulations with the PC 1 polycarbonate mentioned above along with a RDP plasticizer mentioned above were prepared. These five formulations contained either approximately 0%, 5%, 10%, 15%, or 20% by weight of the RDP plasticizer, based on the weight of the PC 1 polycarbonate. All formulations were thoroughly compounded in a twin screw extruder using a melt temperature of 300° C. with a rate of 20 kg/hour, 20 inches of vacuum and a screw speed of approximately 400 RPM.

Three more formulations were prepared with FST resin which is a DAC-Resorcinol-Siloxane-BPA Polyester-Polycarbonate: 1% D10 9010 24.5M [CAS: 915977-87-6]. One of these formulations was 100% by weight FST. The second formulation was approximately 92.5% by weight FST and 7.5% by weight bisphenol A diphosphate, tradename CR-741 [CAS: 5945-33-5][known as BHA-DP]. The third formulation was approximately 93.5% by weight FST and 6.5% by weight of FYROLFLEX SOL-DP aryl phosphate [known as SOL-DP].

Two more formulations were prepared with high flow Polyetherimide-siloxane blend resin [known as PEI-Si]. One of these formulations was 100% by weight PEI-Si. The second formulation was approximately 93.5% by weight FST and 6.5% by weight of FYROLFLEX SOL-DP aryl phosphate [known as SOL-DP].

Description of Lap Shear Adhesion Test:

Sample strips of 5×0.5×0.03 inches (127×12.7×0.76 mm) length×width×thickness of the materials noted below were molded. The plasticized sample strips were cut into 0.5 inch pieces. A 3 layer sandwich structure was prepared where the 2 outer layers were HP6 (control) and the middle layer was the plasticized sample. The outer strips were stacked one on top of the other with 0.5 inch overlap and the plasticized layer in between. The samples were then sandwiched between quarter inch thick metal bars and placed in the oven at optimum temperature for appropriate time. A clip was used to clamp the 2 metal bars to ensure good contact between sample strips. The samples were then taken out and the strips were subjected to lap shear test using an Instron mechanical tester at a temperature of 23° C. and testing speed of 50 mm/min. Comparisons were made among various samples and depending on the decreasing order of force required to peel them apart and observing the sample failure mode, the type of break was classified as cohesive failure, adhesive failure and no breaks or yield and draw. A cohesive failure is defined as any failure or break away from the bonded surface. An adhesive failure is defined as failure at the bonded interface. Type I is defined as adhesive failure, Type II as cohesive failure and Type III as yield and draw i.e. no break.

TABLE 1

| | | Force- | Extension- | |
|---|---|---|---|---|
| Condition | Samples | Break (N) | Break (mm) | Break Type |
| 10 min @ | PC 1 + | 498.6 | 21.9 | Type II |
| 120° C. | 20% RDP | | | |
| | PC 1 | 0 | | No sticking |
| 5 min @ | PC 1 | 100.506 | 1.052 | Type I |
| 160° C. | PC 1 + | 346.24 | 4 | Type I and Type II |
| | 5% RDP | | | |
| | PC 1 + | 377.89 | 21.892 | Type I and Type II |
| | 10% RDP | | | |
| | PC 1 + | 504.664 | 30.712 | Type II and Type III |
| | 15% RDP | | | |
| | PC 1 + | 512.828 | 52.24 | Type II and Type III |
| | 20% RDP | | | |
| 10 min @ | FST | 266 | 2.15 | Type I |
| 150° C. | FST w | 835 | 27.5 | Type II and Type III |
| | BPA-DP | | | |
| | FST w | 739 | 20.6 | Type II and Type III |
| | SOL-DP | | | |
| 10 min @ | PEI-Si | 401 | 2.94 | Type I and Type II |
| 190° C. | PEI-Si w | 830 | 7.77 | Type II and Type III |
| | SOL-DP | | | |

Table 1 above shows results of the lap shear test for PC samples prepared under 2 experimental conditions i.e. temperature/time 120° C./10 min and 160° C./5 min, FST at 150° C./10 min and Ultem 9085 at 190° C./10 min.

It can be seen that when the plasticized sample is used as the middle layer, the 2 PC 1 bars are bonded together and the sample shows Type II or cohesive failure at 120° C. whereas the when the non-plasticized PC 1 sample is used as a middle layer, the 2 PC 1 bars shows no sticking under these experimental conditions. The plasticized sample allows adhesion of the PC 1 bars at a temperature lower than the Tg of PC 1.

At 160° C. it can again be seen that the plasticized PC 1 samples show cohesive failure or no break as the plasticizer percentage increases indicating better interlayer adhesion compared to non-plasticized PC 1 sample that shows Type I or adhesive failure.

The same trend is seen for plasticized FST and PEI-Si samples that show cohesive failure or no break compared to non-plasticized FST and PEI-Si control samples at 150 and 190° C. respectively.

One of the disadvantages of directly using solvents/plasticizers as adhesion promoting layer is the fumes and emissions from solvent evaporation during printing at high temperatures that can cause equipment damage and ventilation and chemical exposure concerns. The use of plasticized polymer as an adhesion promoting layer does not pose such risks and can also be extruded in filaments form for direct use in the FDM process.

The present invention is further illustrated by the following embodiments.

### Embodiment 1

A method of making an article, the method comprising: melt extruding a plurality of layers comprising one or more polymer compositions in a preset pattern, wherein the extruded layers comprise one or more first layers comprising a first polymer composition A, and one or more second layers comprising a second polymer composition B having a chemical composition different from the first polymer composition A, having a glass transition temperature (Tg) that is 5-100 degrees C. lower than polymer composition A, and which acts as a adhesion promotion layer between two layers comprising first polymer composition A; and fusing the plurality of layers to provide the article.

### Embodiment 2

The method of Embodiment 1, comprising melt extruding a plurality of the layers wherein each subsequent layer comprises polymer A or B in an alternating regular sequence AB.

### Embodiment 3

The method of any one or more of Embodiments 1 to 2, wherein each of the layers comprising the first polymer composition A is extruded through the same nozzle and each of the layers comprising second polymer composition B is extruded through a different nozzle.

### Embodiment 4

The method of any one or more of Embodiments 1 to 3, wherein the first polymer composition A comprises a polyacetal, polyacrylate, polyacrylic, polyamide, polyamideimide, polyanhydride, polyarylate, polyarylene ether, polyarylene sulfide, polybenzoxazole, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, polytriazine, polyurea, polyurethane, polyvinyl alcohol, polyvinyl ester, polyvinyl ether, polyvinyl halide, polyvinyl ketone, polyvinylidene fluoride polyvinyl aromatic, polysulfone, polyarylenesulfone, polyaryl ether ketone, polylactic acid, polyglycolic acid, poly-3-hydroxybutyrate, polyhydroxyalkanoate, starch, cellulose ester, or a combination comprising at least one of the foregoing polymers; or the polymer composition comprises a polystyrene, poly(phenylene ether), poly(methyl methacrylate), styrene-acrylonitrile, poly(ethylene oxide), epichlorohydrin polymer, polycarbonate homopolymer, copolycarbonate, poly(ester-carbonate), poly(ester-siloxane-carbonate), poly(carbonate-siloxane), acrylonitrile-butadiene-styrene, or a combination comprising at least one of the foregoing polymers.

### Embodiment 5

The method of any one or more of Embodiments 1 to 4, wherein the first polymer composition A comprises a polystyrene, poly(phenylene oxide), poly(methyl methacrylate), styrene-acrylonitrile, poly(ethylene oxide), epichlorohydrin polymer, polycarbonate homopolymer or copolymer, acrylonitrile-butadiene-styrene, polyimide, polyimide-polycarbonate copolymer or a combination comprising at least one of the foregoing polymers.

### Embodiment 6

The method of any one or more of Embodiments 1 to 5, wherein the second polymer composition B is the same polymer used in the first thermoplastic polymer composition A and an additive that lowers the glass transition temperature (Tg) of that polymer.

### Embodiment 7

The method of Embodiment 6, wherein the additive that lowers the glass transition temperature (Tg) of the polymer comprises a non-brominated and non-chlorinated organic phosphorus-containing additive.

### Embodiment 8

The method of any one or more of Embodiments 1 to 6, wherein the first polymer composition A is a polycarbonate and the second polymer composition B is a combination of the same polycarbonate with an aryl phosphate additive that lowers its Tg.

### Embodiment 9

The method of any one or more of Embodiments 1 to 6, wherein the first polymer composition A is a polyimide and the second polymer composition B is a combination of the same polyimide with an aryl phosphate additive that lowers its Tg.

### Embodiment 10

The method of any one or more of Embodiments 1 to 5, wherein the second thermoplastic polymer composition B comprises a different thermoplastic polymer than the first thermoplastic polymer composition A.

### Embodiment 11

The method of any one or more of Embodiments 1 to 5, wherein the second polymer composition B comprises a solvent and resin paste composition, low molecular weight polymer or oligomer, or a highly plasticized polymer, or a combination comprising at least one of the foregoing thermoplastic polymers.

### Embodiment 12

The method of any one or more of Embodiments 1 to 11 wherein the plurality of layers comprises at least twenty layers.

### Embodiment 13

The method of any of Embodiments 1 to 12, wherein forming a plurality of layers comprises forming a plurality of layers comprising a build material and forming a plurality of layers comprising a support material.

### Embodiment 14

The method of any of Embodiments 1 to 13, wherein the first polymer composition A and the second polymer composition B are miscible or compatible with each other.

### Embodiment 15

An article made by any of the methods of any one or more of Embodiments 1 to 14.

### Embodiment 16

An article comprising a plurality of at least twenty fused layers, each layer comprising a polymer composition, wherein one or more first layers comprising a first polymer composition A. and one or more second layers comprising a second polymer composition B having a chemical structure different from the first polymer, having a glass transition temperature (Tg) that is 5-100 degrees C. lower than polymer composition A, and which acts as a adhesion promotion layer between two layers comprising first polymer composition A, wherein the first thermoplastic polymer composition A and the second thermoplastic polymer composition B are miscible or compatible with each other.

### Embodiment 17

The method of any of claims 1 to 14, wherein the method is a fused filament fabrication additive manufacturing process or a large format additive manufacturing process and the polymer composition is in the form of filaments or pellets.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function and/or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. Reference throughout the specification to “an embodiment”, “another embodiment”, “some embodiments”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making an article, the method comprising:
melt extruding a plurality of layers comprising one or more polymer compositions in a preset pattern, wherein the extruded layers comprise
one or more first layers comprising a first polymer composition A, and
one or more second layers comprising a second polymer composition B having a chemical composition different from the first polymer composition A, having a glass transition temperature (Tg) that is 5-100 degrees C. lower than polymer composition A, and which acts as a adhesion promotion layer between two layers comprising first polymer composition A; and
fusing the plurality of layers to provide the article.

2. The method of claim 1, comprising melt extruding a plurality of the layers wherein each subsequent layer comprises polymer A or B in an alternating regular sequence AB.

3. The method of claim 1, wherein each of the layers comprising the first polymer composition A is extruded through the same nozzle and each of the layers comprising second polymer composition B is extruded through a different nozzle.

4. The method of claim 1, wherein the first polymer composition A comprises a polyacetal, polyacrylate, polyacrylic, polyamide, polyamideimide, polyanhydride, polyarylate, polyarylene ether, polyarylene sulfide, polybenzoxazole, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, polytriazine, polyurea, polyurethane, polyvinyl alcohol, polyvinyl ester, polyvinyl ether, polyvinyl halide, polyvinyl ketone, polyvinylidene fluoride polyvinyl aromatic, polysulfone, polyarylenesulfone, polyaryl ether ketone, polylactic acid, polyglycolic acid, poly-3-hydroxybutyrate, polyhydroxyalkanoate, starch, cellulose ester, or a combination comprising at least one of the foregoing polymers; or the polymer composition comprises a polystyrene, poly(phenylene ether), poly(methyl methacrylate), styrene-acrylonitrile, poly(ethylene oxide), epichlorohydrin polymer, polycarbonate homopolymer, copolycarbonate, poly(ester-carbonate), poly(ester-siloxane-carbonate), poly(carbonate-siloxane), acrylonitrile-butadiene-styrene, or a combination comprising at least one of the foregoing polymers.

5. The method of claim 1, wherein the first polymer composition A comprises a polystyrene, poly(phenylene oxide), poly(methyl methacrylate), styrene-acrylonitrile, poly(ethylene oxide), epichlorohydrin polymer, polycarbonate homopolymer or copolymer, acrylonitrile-butadiene-styrene, polyimide, polyimide-polycarbonate copolymer or a combination comprising at least one of the foregoing polymers.

6. The method of claim 1, wherein the second polymer composition B is the same polymer used in the first thermoplastic polymer composition A and an additive that lowers the glass transition temperature (Tg) of that polymer.

7. The method of claim 6, wherein the additive that lowers the glass transition temperature (Tg) of the polymer comprises a non-brominated and non-chlorinated organic phosphorus-containing additive.

8. The method of claim 1, wherein the first polymer composition A is a polycarbonate and the second polymer composition B is a combination of the same polycarbonate with an aryl phosphate additive that lowers its Tg.

9. The method of claim 1, wherein the first polymer composition A is a polyimide and the second polymer composition B is a combination of the same polyimide with an aryl phosphate additive that lowers its Tg.

10. The method of claim 1, wherein the second thermoplastic polymer composition B comprises a different thermoplastic polymer than the first thermoplastic polymer composition A.

11. The method of claim 1, wherein the second polymer composition B comprises a solvent and resin paste composition, low molecular weight polymer or oligomer, or a highly plasticized polymer, or a combination comprising at least one of the foregoing thermoplastic polymers.

12. The method of claim 1 wherein the plurality of layers comprises at least twenty layers.

13. The method of claim 1, wherein forming a plurality of layers comprises forming a plurality of layers comprising a build material and forming a plurality of layers comprising a support material.

14. The method of claim 1, wherein the first polymer composition A and the second polymer composition B are miscible or compatible with each other

15. An article made by any of the methods of claim 1.

16. An article comprising
a plurality of at least twenty fused layers, each layer comprising a polymer composition, wherein one or more first layers comprising a first polymer composition A, and one or more second layers comprising a second polymer composition B having a chemical structure different from the first polymer, having a glass transition temperature (Tg) that is 5-100 degrees C. lower than polymer composition A, and which acts as a adhesion promotion layer between two layers comprising first polymer composition A, wherein the first thermoplastic polymer composition A and the second thermoplastic polymer composition B are miscible or compatible with each other.

17. The method of claim 1, wherein the method is a fused filament fabrication additive manufacturing process or a large format additive manufacturing process and the polymer composition is in the form of filaments or pellets.
